(19) United States
(12) Patent Application Publication
(10) Pub. No.: US 2019/0204936 A1
(43) Pub. Date: Jul. 4, 2019

(54) APPARATUS AND PROCESS FOR DRAWING LINES

(71) Applicant: Kronos S.r.l., Palosco BG (IT)

(72) Inventors: Roberto LEPORATI, Palosco BG (IT); Giovanni LEPORATI, Palosco BG (IT); Luca LEPORATI, Palosco BG (IT); Dolores LEPORATI, Palosco BG (IT); Stefano LEPORATI, Palosco BG (IT); Odilla LEPORATI, Palosco BG (IT)

(21) Appl. No.: 16/311,800

(22) PCT Filed: Jun. 23, 2016
(86) PCT No.: PCT/IB2016/053736

§ 371 Date: Dec. 20, 2018

(51) Int. Cl. G06F 3/0354; G06F 3/044; G06F 3/041; B43L 9/02

(52) U.S. Cl. CPC G06F 3/0354; B43L 9/025; G06F 3/0416; G06F 3/044

(57) ABSTRACT

An apparatus and a process for drawing lines on a sensitive medium are disclosed. The apparatus comprises at least one tool for drawing lines and a programmable device equipped with a touchscreen, the latter being the sensitive medium. The tool for drawing lines includes a compass comprising a first leg having a drawing means installed thereon, the drawing means being able to interact with the touchscreen of the programmable device.

### FIELD OF THE INVENTION

The present invention relates to an apparatus and a process for drawing lines on a sensitive medium, such as for example the touchscreen of a programmable device.

### PRIOR ART

Devices equipped with “touch-sensitive display” (also known as “touchscreen” or “touch-screen”), for example devices such as smartphones, tablets, notebooks and the like, are becoming very common in the art. These devices can be programmed and are able to run programs (the so-called “apps”) in order to perform several functions, among which reproducing lines and/or drawings taken from a library of images pre-loaded in a memory unit, or even freehand drawing and depicting lines by moving a finger, or a special pen, on the touchscreen.

These devices are certainly useful for making generic and/or technical drawings, but inevitably lead to neglect the use and knowledge of those drawing tools which have been widely used up to now, such as for example straightedges, set squares, compasses or the like. This happens especially among young people born and grown up during the so-called “digital age”, in which programmed devices are widely used.

### SUMMARY OF THE INVENTION

It is an object of the present invention to provide an apparatus able to combine the potential of touchscreen devices with a traditional tool for drawing lines. Another object of the present invention is to provide an apparatus allowing to especially use a compass for drawing both open and closed curved lines on the surface of a touchscreen.

A further object of the present invention is to provide an apparatus allowing to adapt also already existing compass models for drawing both open and closed curved lines on the surface of a touchscreen.

These objects are achieved thanks to an apparatus according to claim 1. Further characteristics of the apparatus of the present invention are disclosed in the dependent claims.

An apparatus for drawing lines on a sensitive support, comprising at least one tool for drawing lines and a programmable device equipped with a touchscreen constituting the sensitive medium, is proposed. According to a preferred aspect of the invention, the tool for drawing lines includes a compass comprising a first leg having a drawing means able to interact with the touchscreen of the programmable device. Therefore, the programmable device equipped with a touchscreen is used as a common sheet on which both open and closed curved lines can be drawn by means of a compass, that is to say a tool normally used in the technical drawing to draw curved lines on a paper material.

The drawing means of the first leg is an accessory removable from the first leg. Thus, the compass can also be used with other drawing means having different shapes and sizes.

The compass preferably comprises a handle made of an electrically conductive material and arranged so as to be electrically connected with the drawing means. In other words, in order to act on the touchscreen, the continuity of the electrical conductivity between the handle and the drawing means must be guaranteed.

For example, the handle and the first leg having the drawing means installed thereon are made of an electrically conductive material, for example a conductive metal, and are connected to each other, not only mechanically but also electrically.

In a possible embodiment, the drawing means is provided with an end portion made of a material having low coefficient of friction and having at least one smooth surface adapted to slidably engage the surface of the sensitive medium. The end portion has to be made of a material able to facilitate the drawing means to slide on the touchscreen without causing the surface thereof to be scratched.

Advantageously, the end portion of the drawing means is connected to a flexible element, for example a spring or the like, in order to guarantee the end portion to swing limitedly. In this way, the contact keeping between the end portion and the touchscreen surface is facilitated regardless of the opening of the compass.

The compass comprises a second leg whose end is provided with a bearing head. The bearing head has at least one flat bearing surface coated with antislip material, such as a silicone rubber or the like, so as to guarantee the stability of the compass during the movement.

The bearing head is also an accessory that can be removed from the second leg. In this way, bearing heads having different shapes and sizes can be used. Moreover, also the existing compasses, often made of conductive metal, can be advantageously used with these accessories installed in place of needle points and lead holders or pencil holders.

The bearing head of the second leg may comprise one or more alignment indicators, for example portions projecting along orthogonal directions.

The bearing head is mechanically connected to the second leg by a ball joint. In this way, the contact between the bearing head and the touchscreen surface is stably kept regardless of the opening of the compass.

Advantageously, according to the invention, a kit of compass accessories can be further provided, the kit comprising at least one drawing means and/or at least one bearing head for a compass of the apparatus described so far. This allows already existing compasses to be advantageously used with the accessories required to draw lines on a sensitive medium.

The programmable device of an apparatus according to the invention is preferably programmed for displaying on the touchscreen the lines drawn by the compass.

The programmable device preferably includes at least one memory unit for storing the lines drawn by the compass.

For example, the touchscreen of the programmable device may be a capacitive touchscreen, i.e. a type of screen very common in programmable devices currently available on the market. However, the touchscreen may also use a different technology.

The use of an apparatus of the heretofore described type is particularly simple and, for example, envisages the steps of:
running, on the programmable device provided with touchscreen, a program allowing the programmable device to interact with the compass of the apparatus;
manually gripping the handle of the compass;
positioning the bearing head, placed at the end of the second leg of the compass, on the surface of the touchscreen, and
pivoting the compass while the drawing means placed at the end of the first leg of the compass is kept in contact with the surface of the touchscreen.

As the compass draws, the drawn lines are advantageously displayed on the touchscreen. Furthermore, the storage of the drawn lines in at least one memory unit of the programmable device can be provided.

In addition, a digital data medium for storing and/or running a computer program is an object of the present invention. The program comprises executable code lines for using an apparatus as the one heretofore described and/or for allowing it to be used. The digital data medium may be, for example, a memory unit integrated in the programmable device equipped with a touchscreen, or it can be a memory unit removable from the same programmable device.

Advantageously, a digital data medium can be also comprised in a kit of compass accessories, for example like a removable memory unit together with a drawing means and/or a bearing head for a compass of the apparatus heretofore described.

The digital data medium stores a program comprising code lines to provide, for example, the functions of:
selecting an arc, semicircle or circle drawing;
managing the diameter of a circle;
closing a circle;
managing the drawing of concentric circles.

The program may also comprise code lines to provide at least the functions of:
selecting the size of a working area at least from an A3 or A4 size of the medium;
selecting the medium background at least from blank, with border or millimeter one;
setting the zoom for displaying the working area;
displaying a ruler.

The program may further comprise code lines to provide at least the functions of:
displaying one or more drawings selected from a collection of pre-installed drawings;
displaying geometric shapes and/or technical drawing symbols;
selecting thickness and color of the drawn lines;
deleting one or more drawn lines;
saving a processed drawing;
deleting a saved drawing;
printing a processed drawing.

### BRIEF DESCRIPTION OF THE DRAWINGS

Further characteristics and advantages of the present invention will be more evident from the following specification of some embodiments depicted for illustrative purposes and without limitation, with particular reference to the accompanying schematic drawings, wherein:

FIG. 1 is an elevation view of a compass ready to be used in an apparatus according to the present invention;

FIG. 2 is an elevation view of the compass of FIG. 1, without its accessories;

FIG. 3 is an elevation view of a drawing means whose components are separated from one another;

FIG. 4 is an elevation view of a bearing head whose components are separated from one another;

FIGS. 4A, 4B and 4C are plan bottom views of the components depicted in FIG. 4; and

FIG. 5 is a perspective view depicting a possible embodiment of an apparatus according to the present invention while in use.

### METHODS FOR CARRYING OUT THE INVENTION

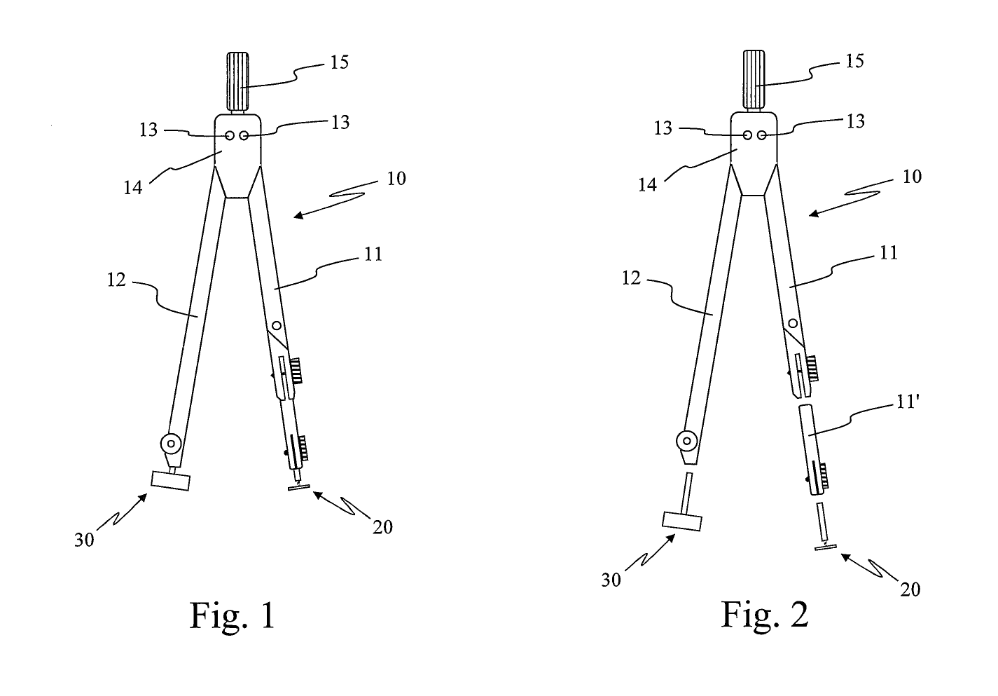

FIGS. 1 and 2 depict a possible embodiment of a compass 10 comprising a first leg 11 and a second leg 12 pivotable around respective pins 13 integral with the body 14 of the compass 10. A handle 15 is constrained to the upper part of the body 14. The legs 11 and 12, the pins 13, the body 14 and the handle 15 are made of an electrically conductive material, such as metal, and are electrically connected to one another. A drawing means 20 able to interact with the touchscreen 110 of a programmable device 100 (FIG. 5) is installed on the first leg 11.

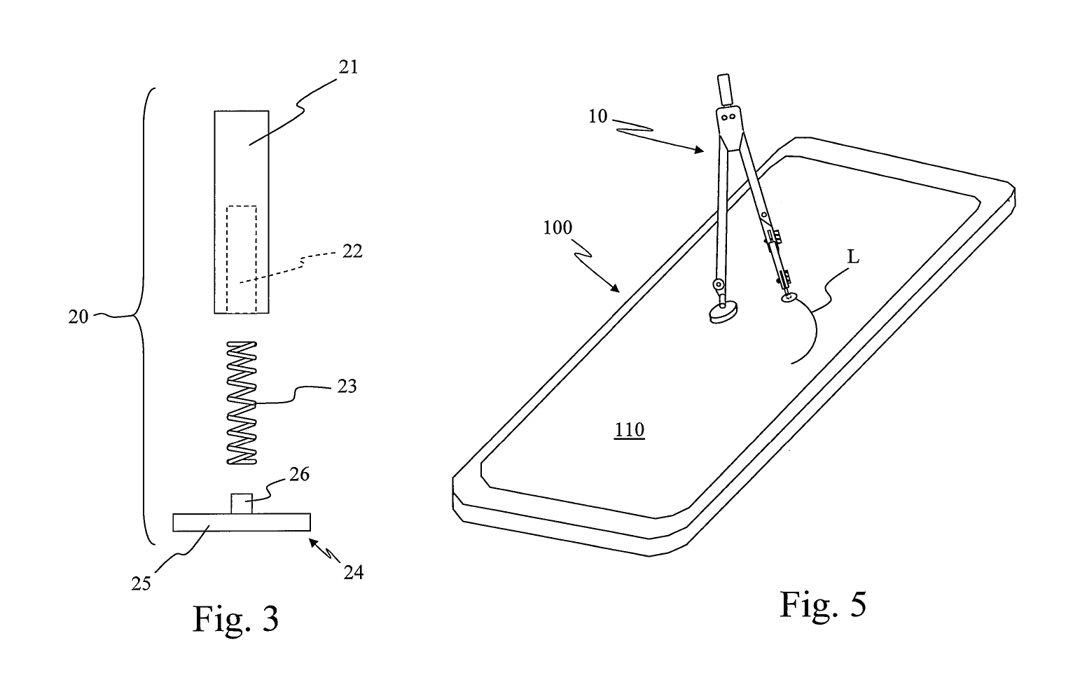

As shown in FIG. 2, the drawing means 20 is an accessory removable from the first leg 11 and can possibly be mounted on a removable portion 11′ also made of an electrically conductive material, which is mounted on the leg 11. The drawing means 20 comprises a pin 21 (FIG. 3) made of an electrically conductive material and electrically connected to the handle 15 by the leg 11, the removable portion 11′, the pins 13 and the body 14 of the compass 10.

A bearing head 30 having at least one flat bearing surface coated with antislip material, is installed at the end of the second leg 12 of the compass 10 depicted in FIGS. 1 and 2. However, also the bearing head 30 is an accessory that can be removed from the second leg 12.

FIG. 3 depicts a possible embodiment of a drawing means 20. The drawing means 20 comprises a pin 21 provided with a recess 22 in which a flexible element is inserted. In the embodiment depicted herein, the flexible element is a spring 23 also made of an electrically conductive material, which is held in position inside the recess 22, for example by a tight fit.

An end portion 24 of the drawing means 20 is made, for example, in the form of a circular plate, of a material having a low coefficient of friction, such as a plastic material still allowing the drawing means 20 to interact with the surface of a touchscreen, such as the touchscreen 110 of the programmable device 100 of FIG. 5. The end portion 24 includes at least, one smooth surface 25 adapted to slidably engage the surface of a touchscreen, or anyway of a sensitive medium. A pin 26 of the end portion 24 is inserted, in its turn, in the spring 23 by a tight fit.

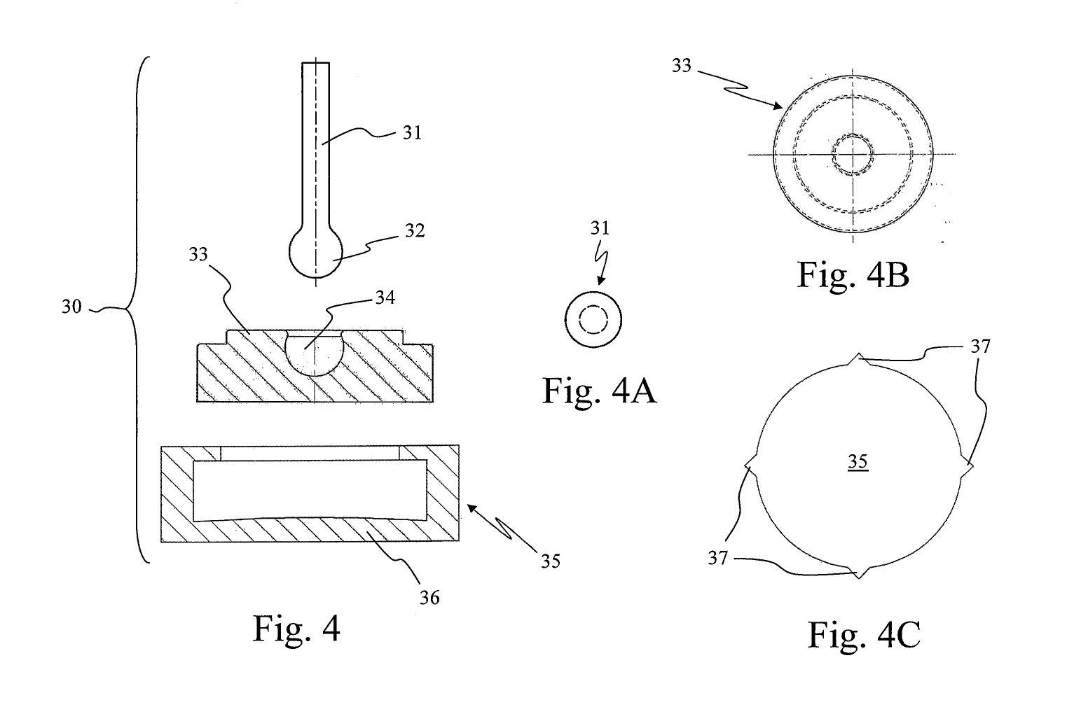

FIG. 4 depicts the components of a bearing head 30 in a separate condition. The bearing head 30 comprises a pin 31 for the connection to the second leg 12 of the compass 10. The pin 31 is provided with a spherical end 32 to be engaged in a spherical seat 34 being in the body 33 of the bearing head 30. The pin 31 and the body 33 of the bearing head 30 are further depicted in bottom plan views in FIGS. 4A and 4B, respectively.

Thus the spherical end 32 of the pin 31, engaged in the spherical seat 34, make a ball joint to connect the bearing head 30 to the second leg 12.

The body 33 of the bearing head 30 is covered with a coating 35 made of antislip material, for example silicone rubber or the like. The coating 35 is provided with a flat bearing surface 36 allowing to stay stably in position on a touchscreen while the compass 10 is in use.

As depicted in the plan bottom view of FIG. 4C, the coating 35 includes one or more alignment indicators which can be, for example, projecting edges 37 arranged along orthogonal directions.

The view of FIG. 5 shows an apparatus according to a possible embodiment of the present invention, comprising in particular a compass 10 and a programmable device 100 equipped with a touchscreen 110 constituting the surface of a sensitive medium on which a curved line L, for example an arc of a circle or even a closed circle, can be drawn.

The programmable device 100 is programmed so that the lines drawn by the compass 10 are displayed on the touchscreen 110, for example a capacitive touchscreen, and can include for example a memory unit for storing the lines drawn by the compass 10.

Several modifications can be made to the embodiments so far depicted for illustration purpose only. For example, the shape and the materials of the drawing means 20 and the bearing head 30 may also vary from those specifically described so far. Similarly, the touchscreen types can also be based on other technologies, less common or not yet available on the market.

1. An apparatus for drawing lines on a sensitive medium, comprising at least one tool for drawing lines and a programmable device equipped with a touchscreen constituting said sensitive medium, characterized in that said tool for drawing lines includes a compass comprising a first leg having a drawing means able to interact with the touchscreen of said programmable device.

2. The apparatus according to claim 1, wherein the drawing means of said first leg is an accessory removable from said first leg.

3. The apparatus according to claim 1, wherein said compass comprises a handle made of an electrically conductive material, and wherein said handle is electrically connected with said drawing means.

4. The apparatus according to claim 3, wherein said handle and said leg, the latter having said drawing means installed thereon, are made of an electrically conductive material and are electrically connected to each other.

5. The apparatus according to claim 1, wherein said drawing means is provided with an end portion made of a material having low coefficient of friction and having at least one smooth surface adapted to slidably engage the surface of said sensitive medium.

6. The apparatus according to claim 5, wherein the end portion of said drawing means is connected to a flexible element.

7. The apparatus according to claim 1, wherein said compass comprises a second leg with a bearing head at the end thereof, the bearing head having at least one flat bearing surface coated with antislip material.

8. The apparatus according to claim 7, wherein said bearing head is an accessory removable from said second leg.

9. The apparatus according to claim 7, wherein the bearing head of said second leg includes one or more alignment indicators.

10. The apparatus according to claim 7, wherein the bearing head is mechanically connected to said second leg by a ball joint.

11. The apparatus according to claim 1, wherein said programmable device is programmed for displaying on said touchscreen the lines drawn by said compass.

12. The apparatus according to claim 1, wherein said programmable device comprises at least one memory unit for storing the lines drawn by said compass.

13. The apparatus according to claim 1, wherein the touchscreen of said programmable device is a capacitive touchscreen.

14. A process for drawing lines on a sensitive medium by means of an apparatus according to claim 1, comprising the steps of:
running, on said programmable device provided with touchscreen, a program allowing the programmable device to interact with the compass of said apparatus;
manually gripping the handle of said compass;
positioning the bearing head, placed at the end of the second leg of said compass, on the surface of said touchscreen, and
pivoting said compass while the drawing means placed at the end of the first leg of said compass is kept in contact with the surface of said touchscreen.

15. The process according to claim 14, wherein the step of displaying on said touchscreen the lines drawn by said compass is provided.

16. The process according to claim 14, wherein said programmable device includes at least one memory unit and wherein the step of storing the lines drawn by said compass is provided.

17. A digital data medium for storing and/or running a computer program, wherein said program comprises executable code lines so as to use an apparatus according to claim 1 for drawing lines on a sensitive medium and/or to carry out a process for drawing lines on a sensitive medium, said process comprising the steps of:
running, on said programmable device provided with touchscreen, a program allowing the programmable device to interact with the compass of said apparatus;
manually gripping the handle of said compass;
positioning the bearing head, placed at the end of the second leg of said compass, on the surface of said touchscreen, and
pivoting said compass while the drawing means placed at the end of the first leg of said compass is kept in contact with the surface of said touchscreen.

18. The digital data medium according to claim 17, wherein the digital data medium is constituted by a memory unit integrated in said programmable device equipped with a touchscreen.

19. The digital data medium according to claim 17, wherein the digital data medium is constituted by a memory unit removable from said programmable device equipped with a touchscreen.

20. The digital data medium according to claim 17, wherein said program comprises code lines to provide at least the functions of:
selecting an arc, semicircle or circle drawing;
managing the diameter of a circle;
closing a circle;
managing the drawing of concentric circles.

21. The digital data medium according to claim 17, wherein said program comprises code lines to provide at least the functions of:
selecting the size of a working area at least from an A3 or A4 size of the medium;
selecting the medium background at least from blank, with border or millimeter one;
setting the zoom for displaying the working area;
displaying a ruler.

22. The digital data medium according to claim 17, wherein said program comprises code lines to provide at least the functions of:
displaying one or more drawings selected from a collection of pre-installed drawings;
displaying geometric shapes and/or technical drawing symbols;
selecting thickness and color of the drawn lines;
deleting one or more drawn lines;
saving a processed drawing;
deleting a saved drawing;
printing a processed drawing.

23. A kit of compass accessories for an apparatus according to claim 1, said kit comprising at least one drawing means, at least one bearing head and at least one digital data medium constituted by a removable memory unit.

24-25. (canceled)
